(19) United States
(12) Patent Application Publication
(10) Pub. No.: US 2026/0171449 A1
(43) Pub. Date: Jun. 18, 2026

(54) FUEL CELL PERFORMANCE ESTIMATION DEVICE

(71) Applicants: KABUSHIKI KAISHA TOYOTA CHUO KENKYUSHO, Nagakute-shi, Aichi-ken (JP); DENSO CORPORATION, Kariya-shi, Aichi-ken (JP)

(72) Inventors: Norihiro FUKAYA, Nagakute-shi (JP); Takao WATANABE, Nagakute-shi (JP); Naoyuki YAMADA, Kariya-shi (JP); Naoya WAKAYAMA, Kariya-shi (JP); Kohei KAWABATA, Kariya-shi (JP)

(73) Assignees: KABUSHIKI KAISHA TOYOTA CHUO KENKYUSHO, Nagakute-shi, Aichi-ken (JP); DENSO CORPORATION, Kariya-shi, Aichi-ken (JP)

(21) Appl. No.: 18/713,042

(22) PCT Filed: Jan. 31, 2023
(86) PCT No.: PCT/JP2023/002991

§ 371 Date: May 23, 2024

(30) Foreign Application Priority Data
Feb. 28, 2022 (JP) 2022-030457

(51) Int. Cl. H01M 8/04537; H01M 8/10

(52) U.S. Cl. CPC H01M 8/04641; H01M 8/04552; H01M 8/04582; H01M 8/10

(57) ABSTRACT

A fuel cell performance estimation device includes (A) a first means configured to sequentially acquire a voltage V[i] and current I[i] of a polymer electrolyte fuel cell at a time[i] and store them in a memory, (B) a second means configured to calculate a catalyst potential V_{cat}[i] of a cathode at the time[i], calculate an effective surface utilization factor θ_{act}[i] of noble metal-based catalyst particles at the time[i] using the V_{cat}[i], and store them in the memory, (C) a third means configured to calculate an electrode catalyst surface area A_{ECS}[i] at the time[i] and an activity SA[i] per surface area of the particles using the V[i], the V_{cat}[i], and/or integration time of power generation, and store them in the memory, and (D) a fourth means configured to calculate an estimated value IVₑₛₜ[i] of IV characteristics using the θ_{act}[i], the A_{ECS}[i] and the SA[i] and store the IVₑₛₜ[i] in the memory.

### FIELD OF THE INVENTION

The present invention relates to a fuel cell performance estimation device, and more particularly to a fuel cell performance estimation device capable of estimating net performance of a polymer electrolyte fuel cell that has deteriorated over time.

### BACKGROUND OF THE INVENTION

A polymer electrolyte fuel cell includes a membrane electrode assembly (MEA) in which a catalyst layer containing a catalyst is bonded to both surfaces of an electrolyte membrane. The catalyst layer is a portion serving as a reaction field of an electrode reaction, and generally includes a composite of a carbon carrying catalyst particles such as platinum and a solid polymer electrolyte (catalyst layer ionomer).

In the polymer electrolyte fuel cell, a gas diffusion layer is usually disposed outside the catalyst layer. Further, a current collector (separator) including a gas flow path is disposed outside the gas diffusion layer. The polymer electrolyte fuel cell usually has a structure (fuel cell stack) in which a plurality of unit cells, each including such an MEA, a gas diffusion layer, and a current collector, are stacked.

When the polymer electrolyte fuel cell is used as an in-vehicle power source, the voltage of the polymer electrolyte fuel cell greatly fluctuates according to the traveling condition of the vehicle. When the polymer electrolyte fuel cell is in a low load state, the power generation efficiency becomes high, but a cathode catalyst is exposed to a high potential state, so that the catalyst component is easily eluted from the cathode catalyst. On the other hand, when the polymer electrolyte fuel cell is in a high load state, although the power generation efficiency becomes low, but the cathode catalyst is exposed to a low potential state, so that the eluted catalyst component is likely to be reprecipitated on the surface of the cathode catalyst. Therefore, when the cathode catalyst is repeatedly exposed to a high potential state and a low potential state, there is a problem that the cathode catalyst is gradually deteriorated.

On the other hand, the performance of the polymer electrolyte fuel cell is affected not only by the steady voltage reduction caused by such catalyst deterioration but also by temporary voltage fluctuation caused by fluctuation in the power generation condition (that is, voltage fluctuation caused by formation/reduction of oxide film on catalyst surface). It is therefore difficult to accurately estimate the true performance of the polymer electrolyte fuel cell at the present time only by monitoring the voltage of the polymer electrolyte fuel cell that changes from moment to moment.

In order to solve this problem, various proposals have been made heretofore.

For example, Patent Literature 1 discloses a fuel cell power generation monitoring system that:
(a) measures a fuel cell stack voltage of a fuel cell power generation system;
(b) changes the fuel cell effective electrode area of a simulation model such that the stack voltage of the simulation model follows the fuel cell stack voltage; and
(c) determines that there is abnormal condition when the fuel cell effective electrode area in the simulation model is outside normal range.

Patent Literature 1 describes that
(A) by such a method, it is possible to accurately monitor a deterioration state inside the fuel cell power generation system; and
(B) using such a simulation model, it is possible to obtain a future predicted value of the fuel cell effective electrode area when the operation is continued under the present conditions.

Patent Literature 2 discloses a control device of a fuel cell system that:
(a) sets a time (learning stop time) from the start of the power generation to the occurrence of the change in the current-voltage characteristics due to the formation of the oxide film on the catalyst of the oxidant electrode in advance;
(b) approximates the relationship between the current X and the voltage Y of the fuel cell by a linear expression: Y=A×X+B, and updates the parameters A and B using the current X and the voltage Y acquired from the start of power generation until the learning stop time is reached;
(c) by substituting the rated current Iₘₐₓ of the fuel cell into a primary expression including the updated parameters A and B, calculates an expected voltage Vₘᵢₙ (=A×Iₘₐₓ+B) with respect to Iₘₐₓ; and
(e) determines that fuel cell is deteriorated when the Vₘᵢₙ is a predetermined value or less.

Patent Literature 2 describes that:
(A) when an oxide film is formed on the catalyst of the oxidant electrode, a recoverable characteristic change occurs, but when a deterioration diagnosis is performed based on the recoverable characteristic change, a wrong deterioration diagnosis is performed; and
(B) in a case where the current-voltage characteristics of the fuel cell is approximated by the primary expression, when the calculation for updating the parameters A and B is stopped before the oxide film is formed on the catalyst of the oxidant electrode (before the learning stop time is reached), the characteristic change caused by the formation of the oxide film is not considered in updating the parameters A and B, so that the deterioration of the fuel cell can be accurately detected.

Patent Literature 3 discloses the fuel cell system that:
(a) in a case where the initial value of the voltage of the fuel cell is V₁, the voltage immediately after the Nth starting is V₂ₙ, the voltage after the elapse of the elapsed time Tₙ from the Nth starting is V₃ₙ, and the voltage when the oxide film on the cathode catalyst surface is reduced by the crossover hydrogen after the Nth operation is stopped is V₄ₙ, estimates a recoverable voltage reduction amount (=V₄ₙ−V₃ₙ) after the Nth operation stop based on Tₙ;
(b) calculates an unrecoverable voltage reduction amount (=V₁−V₄ₙ) by subtracting the recoverable voltage reduction amount (=V₄ₙ−V₃ₙ) from the total voltage reduction amount (=V₁−V₃ₙ); and
(c) determines that the fuel cell is deteriorated when the unrecoverable voltage reduction amount is predetermined value or more.

Patent Literature 3 describes that the unrecoverable voltage reduction amount can be accurately estimated by such a method.

Further, Patent Literature 4 discloses a fuel cell system that:
(a) acquires a relationship between an oxidation/reduction reaction rate of a Pt catalyst used in a fuel cell and an output voltage or a temperature of the fuel cell by using an operation state acquisition means; and
(b) obtains a current/voltage hysteresis H based on the obtained relationship by using characteristic estimation means, and estimates IV characteristics based on the obtained current/voltage hysteresis H.

The method described in Patent Literature 1 is a method of determining that the fuel cell is abnormal when the fuel cell effective electrode area is out of the normal range, and does not consider temporary fluctuation in cell voltage. Therefore, the simulation model may be corrected by regarding the temporal fluctuation in cell voltage as a change in fuel cell effective electrode area. As a result, there is a possibility that an abnormality is detected even though the fuel cell is normal.

In the method described in Patent Literature 2, a learning stop time is set, and data after voltage fluctuation caused by an oxide is prevented from being used for updating the parameters A and B, thereby suppressing erroneous deterioration diagnosis. However, fuel cells generally generate power in a state where an oxide adheres to a catalyst surface. Therefore, the method described in Patent Literature 2 has a problem that accurate deterioration diagnosis cannot be performed in most of the period during power generation.

In the methods described in Patent Literature 3 and Patent Literature 4, the current-voltage characteristics are corrected by organizing the influence of the oxide based on the elapsed time or hysteresis, and the presence or absence of deterioration is determined using the corrected current-voltage characteristics. However, fuel cells used in vehicles and the like rarely continue to operate at a constant load, and usually change in current and voltage in a complicated pattern. Therefore, in the method of correcting the current-voltage characteristics using the elapsed time and the hysteresis, the estimation accuracy of the deterioration may be lowered.

Further, the performance of the fuel cell changes not only by a steady voltage reduction due to catalyst deterioration and a temporary voltage fluctuation due to formation/reduction of an oxide film on the catalyst surface but also by a voltage reduction due to a failure (an irreversible voltage reduction that accidentally occurs due to a cause other than catalyst deterioration). However, no such example of a fuel cell failure determination device has been proposed previously, which is capable of accurately determining a voltage reduction caused by failure, without being affected by a steady voltage reduction or temporary voltage fluctuation.

### CITATION LIST

### Patent Literature

[Patent Literature 1] Japanese Unexamined Patent Application Publication No. 2007-305327
[Patent Literature 2] Japanese Unexamined Patent Application Publication No. JP 2006-139935
[Patent Literature 3] Japanese Unexamined Patent Application Publication No. 2006-147404
[Patent Literature 4] PCT International Publication No. WO 2011/036765

### SUMMARY OF THE INVENTION

An object of the present invention is to provide a fuel cell performance estimation device capable of estimating net performance of a polymer electrolyte fuel cell that has deteriorated over time.

Another object of the present invention is to provide a fuel cell performance estimation device capable of accurately determining the presence or absence of a failure.

In order to solve the above problems, a fuel cell performance estimation device according to the present invention includes
(A) a first means configured to sequentially acquire at least a voltage V[i] and a current I[i] of a polymer electrolyte fuel cell at a time[i] and store the V[i] and the I[i] in a memory,
(B) a second means configured to calculate a catalyst potential V_{cat}[i] of a cathode of the polymer electrolyte fuel cell at the time[i] using at least the V[i],
calculate an effective surface utilization factor θ_{act}[i] of noble metal-based catalyst particles contained in the polymer electrolyte fuel cell at the time[i] using the V_{cat}[i], and
store the V_{cat}[i] and the θ_{act}[i] in the memory,
(C) a third means configured to calculate an electrode catalyst surface area A_{ECS}[i] at the time[i] and an activity SA[i] per surface area of the noble metal-based catalyst particles at the time[i] using the V[i], the V_{cat}[i], and/or an integration time of power generation of the polymer electrolyte fuel cell and store the A_{ECS}[i] and the SA[i] in the memory, and
(D) a fourth means configured to calculate an estimated value IVₑₛₜ[i] of IV characteristics representing a relationship between the I[i] and an estimated voltage Vₑₛₜ[i] of the polymer electrolyte fuel cell using the θ_{act}[i], the A_{ECS}[i], and the SA[i] and store the IVₑₛₜ[i] in the memory.

The fuel cell performance estimation device according to the present invention may further include
(E) a fifth means configured to determine a failure of the polymer electrolyte fuel cell using the IVₑₛₜ[i].

When the voltage V[i] and the current I[i] of the polymer electrolyte fuel cell at the time[i] are sequentially acquired, the catalyst potential V_{cat}[i] of the cathode can be calculated using at least the V[i]. When the V_{cat}[i] is known, the effective surface utilization factor θ_{act}[i] of the noble metal-based catalyst particles can be calculated. The θ_{act}[i] correlates with temporary voltage fluctuation caused by formation/reduction of an oxide film.

In addition, when the V[i], the V_{cat}[i], or the integration time of power generation is known, the electrode catalyst surface area A_{ECS}[i] at the time[i] and the activity SA[i] per surface area of the noble metal-based catalyst particles at the time[i] can be calculated using these. Both A_{ECS}[i] and SA[i] are correlated with a steady voltage reduction due to catalyst deterioration.

Further, using the acquired I[i] and the calculated θ_{act}[i], A_{ECS}[i], and SA[i], the estimated value IVₑₛₜ[i] of the IV characteristics of the polymer electrolyte fuel cell at time[i] can be calculated. The IVₑₛₜ[i] thus obtained represents the current-voltage characteristics in which the influence of a steady voltage reduction due to catalyst deterioration and the influence of a temporary voltage fluctuation due to the formation/reduction of an oxide film on the catalyst surface are excluded (that is, the estimated value of the current-voltage characteristics in a case where it is assumed that no failure has occurred). Therefore, by comparing the actual current-voltage characteristics IV[i] of the polymer electrolyte fuel cell at the time[i] with IVₑₛₜ[i], the presence or absence of the failure can be accurately determined.

### BRIEF DESCRIPTION OF THE DRAWINGS

FIG. 1 is a cross-sectional schematic view of a Pt particle having an oxide film formed thereon;

FIG. 2 is a flowchart for calculating an estimated value IVₑₛₜ[i] of current-voltage characteristics and performing failure determination;

FIG. 3 is a diagram illustrating a relationship among an estimated value IVₑₛₜ[i] of current-voltage characteristics, a sensor value 1 (a measured value IV[i] of the current-voltage characteristics at the normal time), and a sensor value 2 (a measured value IV′[i] of the current-voltage characteristics at the time of failure);

FIG. 4A is a schematic diagram of current-voltage characteristics when power is generated under a specific power generation condition; FIG. 4B is a schematic diagram of current fluctuation and voltage fluctuation during operation of a fuel cell (FC) vehicle; FIG. 4C is a schematic diagram of measured values of the current-voltage characteristics obtained by making the relationship between the current and the voltage illustrated in FIG. 4B a scatter diagram; and

FIG. 5 is a schematic diagram of failure determination using an estimated value IVₑₛₜ[i] of current-voltage characteristics.

### DETAILED DESCRIPTION OF PREFERRED EMBODIMENTS

Hereinafter, an embodiment of the present invention will be described in detail.

### 1. Fuel Cell Performance Estimation Device

A fuel cell performance estimation device according to the present invention includes
(A) a first means configured to sequentially acquire at least a voltage V[i] and a current I[i] of a polymer electrolyte fuel cell at a time[i] and store the V[i] and the I[i] in a memory,
(B) a second means configured to calculate a catalyst potential V_{cat}[i] of a cathode of the polymer electrolyte fuel cell at the time[i] using at least the V[i],
calculate an effective surface utilization factor θ_{act}[i] of noble metal-based catalyst particles contained in the polymer electrolyte fuel cell at the time[i] using the V_{cat}[i], and
store the V_{cat}[i] and the θ_{act}[i] in the memory,
(C) a third means configured to calculate an electrode catalyst surface area A_{ECS}[i] at the time[i] and an activity SA[i] per surface area of the noble metal-based catalyst particles at the time[i] using the V[i], the V_{cat}[i], and/or an integration time of power generation of the polymer electrolyte fuel cell and store the A_{ECS}[i] and the SA[i] in the memory, and
(D) a fourth means configured to calculate an estimated value IVₑₛₜ[i] of IV characteristics representing a relationship between the I[i] and an estimated voltage Vₑₛₜ[i] of the polymer electrolyte fuel cell using the θ_{act}[i], the A_{ECS}[i], and the SA[i] and store the IVₑₛₜ[i] in the memory.

The fuel cell performance estimation device according to the present invention may further include
(E) a fifth means configured to determine a failure of the polymer electrolyte fuel cell using the IVₑₛₜ[i].

### [1.1. First Means]

The first means is a means configured to sequentially acquire at least a voltage V[i] and a current I[i] of the polymer electrolyte fuel cell at a time[i] and store the V[i] and the I[i] in the memory.

The first means may further include a means configured to sequentially acquire the high frequency impedance R[i] of the polymer electrolyte fuel cell at the time[i], in addition to V[i] and I[i], and store the R[i] in the memory.

The first means may further include a means configured to sequentially acquire the high frequency impedance R[i], the temperature T_{FC}[i], the cathode air pressure P_{ca}[i], and the cathode air stoichiometric ST_{ca}[i] of the polymer electrolyte fuel cell at the time[i], in addition to V[i] and I[i], and store them in the memory.

The method of acquiring various physical property values (that is, V[i], I[i], R[i], T_{FC}[i], P_{ca}[i], and ST_{ca}[i]) in the first means is not particularly limited, and an optimum method can be selected according to the type of physical property value. For example, the R[i] is preferably measured by superimposing a high frequency on the I[i] or the V[i] by FDC or the like.

In the present invention, “the temperature T_{FC}[i] of the polymer electrolyte fuel cell” strictly refers to the temperature of the cathode catalyst, but when the temperature of the cathode catalyst cannot be directly measured, it is preferable to measure a temperature that can be equated with the temperature of the cathode catalyst (for example, the temperature of the cooling water discharged from the polymer electrolyte fuel cell). The same applies to other physical property values, and for a physical property value X that is difficult to directly measure, another physical property value X′ that can be equated with the physical property value X and is easy to measure may be substituted.

These physical property values acquired by the first means are used for calculating various physical property values necessary for calculating the estimated value IVₑₛₜ[i] of the IV characteristics.

For example, the V[i] is used for calculating the catalyst potential V_{cat}[i] of the cathode catalyst. In addition to the V[i], the I[i] and the R[i] may also be used for calculating the catalyst potential V_{cat}[i] of the cathode catalyst. The calculated V_{cat}[i] is further used for calculating other physical property values necessary for calculating the estimated value IVₑₛₜ[i] of the IV characteristics.

In addition, the R[i], the T_{FC}[i], the P_{ca}[i], and the ST_{ca}[i] may be used for more accurate calculation of the estimated value IVₑₛₜ[i] of the IV characteristics.

Here, the “voltage V[i]” refers to a potential difference between both ends of the fuel cell stack (that is, the total voltage of the polymer electrolyte fuel cell) at the time[i].

The “catalyst potential V_{cat}[i] of the cathode catalyst” strictly refers to a value obtained by adding a potential drop caused by internal resistance to the potential of the cathode of each unit cell. The V_{cat}[i] is strictly calculated based on the V[i], the I[i], and the R[i], but when the R[i] cannot be acquired, the V_{cat}[i] may be calculated by approximate calculation using only the V[i]. Details of a method of calculating the V_{cat}[i] will be described later.

### [1.2. Second Means]

The second means is a means configured to calculate the catalyst potential V_{cat}[i] of a cathode of the polymer electrolyte fuel cell at the time[i] using at least the V[i],
calculate the effective surface utilization factor θ_{act}[i] of noble metal-based catalyst particles contained in the polymer electrolyte fuel cell at the time[i] using the V_{cat}[i], and
store the V_{cat}[i] and the θ_{act}[i] in the memory.

### [1.2.1. Calculation of V_{cat}[i]]

First, the catalyst potential V_{cat}[i] of a cathode of the polymer electrolyte fuel cell at the time[i] is calculated using at least the V[i]. The calculated V_{cat}[i] is stored in the memory.

In the present invention, the method of calculating the V_{cat}[i] is not particularly limited. For example, the second means may include a means configured to calculate the V_{cat}[i] using the following formula (1).

The V_{cat}[i] expressed by the formula (1) is an approximate expression of the V_{cat}[i] in which the potential drop caused by the internal resistance is ignored. The formula (1) is inferior in calculation accuracy to formula (2) described later. However, when the formula (1) is used, the V_{cat}[i] can be calculated without using the I[i] and the R[i], so that the calculation of the V_{cat}[i] can be simplified.

$$\begin{matrix}[ Math . 1 ] & \\ {V}_{cat} [ i ] = \frac{V [ i ]}{{N}_{c e l l}} & ( 1 )\end{matrix}$$

wherein, N_{cell} is the number of stacked cells of the polymer electrolyte fuel cell.

In addition, the second means may include a means configured to calculate the V_{cat}[i] using the following formula (2) instead of or in addition to the above-described formula (1).

The V_{cat}[i] is strictly expressed by the formula (2). In the formula (2), the first term on the right side represents a potential difference between both ends of the unit cell (cell voltage). In the first term on the right side, the potential per cell is calculated by dividing the V[i] by N_{cell}. The second term on the right side represents the potential drop due to the internal resistance per unit cell. In the second term on the right side, the I[i] and the R[i] are each converted into values per area or per cell. By using the formula (2), the V_{cat}[i] can be accurately calculated. In order to accurately calculate the IVₑₛₜ[i], it is preferable to use the formula (2) for calculating the V_{cat}[i].

$$\begin{matrix}[ Math . 2 ] & \\ {V}_{c a t} [ i ] = \frac{V [ i ]}{{N}_{c e l l}} + ( \frac{I [ i ]}{{A}_{c e l l}} \times \frac{R [ i ] \times {A}_{c e l l}}{{N}_{c e l l}} ) & ( 2 )\end{matrix}$$

wherein,
N_{cell} is the number of stacked cells of the polymer electrolyte fuel cell, and
A_{cell} is an area of the cell.
   [1.2.2. Calculation of θ_{act}[i]]

Next, the effective surface utilization factor θ_{act}[i] of the noble metal-based catalyst particles contained in the polymer electrolyte fuel cell at the time[i] is calculated using the V_{cat}[i]. The calculated θ_{act}[i] is stored in the memory.

Here, the “effective surface utilization factor θ_{act}[i]” refers to the ratio of the area of the surface used for the oxygen reduction reaction (ORR) (that is, the surface not covered with the oxide film) to the surface area of the noble metal-based catalyst particles.

### [A. Noble Metal-Based Catalyst Particles]

In the present invention, the “noble metal-based catalyst particles (hereinafter, also simply referred to as “catalyst particles”)” refer to particles composed of a metal or an alloy containing a noble metal element and having oxygen reduction reaction (ORR) activity.

In the present invention, the material of the catalyst particles is not particularly limited as long as it exhibits ORR activity. Examples of the material of the catalyst particles include
(a) a noble metal (Au, Ag, Pt, Pd, Rh, Ir, Ru, Os),
(b) an alloy containing two or more noble metal elements, and
(c) an alloy containing one or two or more noble metal elements and one or two or more base metal elements (for example, Fe, Co, Ni, Cr, V, Ti, and the like).

### [B. Kind of Oxide]

When the catalyst particles on the cathode side are exposed to a high potential, a catalyst component is likely to elute from the catalyst particles. On the other hand, when the catalyst particles are exposed to a high potential, an oxide film (including a hydroxide) is formed on the surface of the catalyst particles, and elution of the catalyst component from the catalyst particles is suppressed. However, since the formation rate of the oxide film is slow, a rapid fluctuation of the potential of the cathode retards the formation of the oxide film, making it easier to elute the catalyst component from the catalyst particles. That is, when the fuel cell is continuously used under the environment in which the rapid potential fluctuation is repeated, the catalyst particles are eventually deteriorated.

In other words, the durability of the noble metal-based catalyst particles on the cathode side depends on the total amount of the noble metal oxide and the noble metal hydroxide present on the surface of the noble metal-based catalyst particles.

On the other hand, among surfaces of the noble metal-based catalyst particles, the surface covered with the oxide film has lower ORR activity than the surface not covered with the oxide film. Therefore, the IV characteristics of the polymer electrolyte fuel cell depends on the θ_{act}[i] of the catalyst particles.

The noble metal oxide present on the surface of the noble metal-based catalyst particles is roughly classified into
(a) a noble metal hydroxide adsorbed on the surface of the noble metal-based catalyst particles,
(b) a noble metal oxide adsorbed on the surface of the noble metal-based catalyst particles, and
(c) a noble metal oxide formed just below the surface of the noble metal-based catalyst particles by the diffusion of oxygen into the inside of the particles.

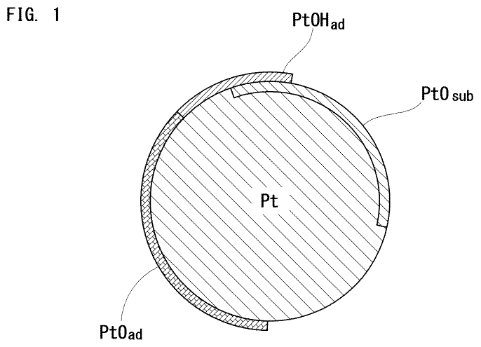

FIG. 1 illustrates a cross-sectional schematic view of a Pt particle having an oxide film formed thereon. When the Pt particle is exposed to a high potential, an oxide (including a hydroxide) is formed on the surface of the Pt particle.

In this case, the oxide on the surface of the Pt particle includes
(a) a Pt hydroxide (PtOH_{ad}) adsorbed on the surface of the Pt particle,
(b) a Pt oxide (PtO_{ad}) adsorbed on the surface of the Pt particle, and
(c) a Pt oxide (PtO_{sub}) formed just below the surface of the Pt particle by the diffusion of oxygen into the inside of the Pt particle.

Here, the coverage of the noble metal hydroxide adsorbed on the surface of the noble metal-based catalyst particles such as the PtOH_{ad} at time[i] is defined as θₒₓ₁[i]. θₒₓ₁[i] is represented by a ratio (=S₁/S₀) of an area (S₁) of the noble metal hydroxide adsorbed on the surface of the noble metal-based catalyst particles to a surface area (S₀) of the noble metal-based catalyst particles.

Similarly, the coverage of the noble metal oxide adsorbed on the surface of the noble metal-based catalyst particles such as the PtO_{ad} at time[i] is defined as θₒₓ₂[i]. θₒₓ₂[i] is represented by a ratio (=S₂/S₀) of an area (S₂) of the noble metal oxide adsorbed on the surface of the noble metal-based catalyst particles to S₀.

Similarly, the coverage of the noble metal oxide present inside the noble metal-based catalyst particles such as the PtO_{sub} at time[i] is defined as θₒₓ₃[i]. θₒₓ₃[i] is represented by a ratio (=S₃/S₀) of an area (S₃) of the noble metal oxide present inside the noble metal-based catalyst particles to S₀.

As illustrated in FIG. 1, the PtO_{sub} may be formed just below a region where the PtOH_{ad} or the PtO_{ad} has adsorbed on the surface of Pt particle. Therefore, the coverage of the entire Pt particle does not necessarily match the sum of θₒₓ₁[i] to θₒₓ₃[i].

θₒₓ₁[i] to θₒₓ₃[i] can be determined by sequentially calculating using a reaction model based on a reaction rate equation. In addition, when θₒₓ₁[i] to θₒₓ₃[i] are found, the θ_{act}[i] can be calculated using them.

### [C. Reaction Model]

There are various methods for calculating the θ_{act}[i]. In the present invention, a method of calculating the θ_{act}[i] is not particularly limited, and an optimum method can be used according to the purpose. The calculated θ_{act}[i] is stored in the memory.

Specifically, the second means preferably includes a means configured to calculate the θ_{act}[i] using the following formula (3) and/or formula (4). Any one of these may be used for calculating the θ_{act}[i], or these may be used depending on the purpose.

$$\begin{matrix}[ Math . 3 ] & \\ {θ}_{act} [ i ] = {α}_{1} - {α}_{2} ( {θ}_{ox 1} [ i ] + {θ}_{o x 2} [ i ] ) - {α}_{3} \frac{{θ}_{o x 3} [ i ]}{( {θ}_{o x 1} [ i ] + {θ}_{o x 2} [ i ] )} & ( 3 )\end{matrix}$$

$${θ}_{a c t} [ i ] = {α}_{1} - {α}_{2} \times {θ}_{o x 1} [ i ] - {α}_{3} \times {θ}_{ox 2} [ i ] - {α}_{4} \times {θ}_{o x 3} [ i ] \qquad ( 4 )$$

$${θ}_{o x 1} [ i ] = {θ}_{o x 1} [ i - 1 ] + {T}_{s} \times \frac{{v}_{1} - {v}_{2}}{Γ}$$

$${θ}_{o x 2} [ i ] = {θ}_{o x 2} [ i - 1 ] + {T}_{s} \times \frac{{v}_{2} - {v}_{3}}{Γ}$$

$${θ}_{o x 3} [ i ] = {θ}_{o x 3} [ i - 1 ] + {T}_{s} \times \frac{{v}_{3}}{Γ}$$

$${v}_{1} = {α}_{11} \text{} \{ ( 1 - {θ}_{o x 1} [ i - 1 ] - {θ}_{o x 2} [ i - 1 ] ) \times exp ( {α}_{12} \times {G}_{1} ) - {θ}_{o x 1} [ i - 1 ] \times exp ( - {α}_{13} \times {G}_{1} ) \}$$

$${v}_{2} = {α}_{21} \{ {θ}_{o x 1} [ i - 1 ] \times exp ( {α}_{22} \times {G}_{2} ) - {θ}_{o x 2} [ i - 1 ] \times exp ( - {α}_{23} \times {G}_{2} ) \}$$

$${v}_{3} = {α}_{31} \{ ( 1 - {θ}_{o x 3} [ i - 1 ] ) \times {θ}_{o x 2} [ i - 1 ] \times exp ( {α}_{32} \times {G}_{3} ) - {θ}_{o x 3} [ i - 1 ] \times ( 1 - {θ}_{o x 1} [ i - 1 ] - {θ}_{o x 2} [ i - 1 ] ) \times exp ( - {a}_{33} \times {G}_{3} ) \}$$

$${G}_{1} = {V}_{c a t} [ i ] - {α}_{14} - {α}_{15} \times {θ}_{o x 1} [ i - 1 ] - {α}_{16} \times {θ}_{o x 2} [ i - 1 ] - {α}_{17} \times {θ}_{o x 3} [ i - 1 ]$$

$${G}_{2} = {V}_{c a t} [ i ] - {α}_{24} - {α}_{25} \times {θ}_{o x 1} [ i - 1 ] - {α}_{26} \times {θ}_{o x 2} [ i - 1 ] - {α}_{27} \times {θ}_{0 x 3} [ i - 1 ]$$

$${G}_{3} = {V}_{c a t} [ i ] - {α}_{34} - {α}_{35} \times {θ}_{o x 1} [ i - 1 ] - {α}_{36} \times {θ}_{o x 2} [ i - 1 ] - {α}_{37} \times {θ}_{o x 3} [ i - 1 ]$$

wherein,
θₒₓ₁[i] is a coverage of the noble metal hydroxide adsorbed on the surface of the noble metal-based catalyst particles at the time[i],
θₒₓ₂[i] is a coverage of the noble metal oxide adsorbed on the surface of the noble metal-based catalyst particles at the time[i],
θₒₓ₃[i] is a coverage of the noble metal oxide present inside the noble metal-based catalyst particles at the time[i],
Γ is the maximum surface covering oxygen amount (constant) per unit surface area,
Tₛ is a calculation step width, and
α₁ to α₄, α₁₁ to α₁₇, α₂₁ to α₂₇, and α₃₁ to α₃₇ are each a fitting coefficient.

Specifically, Tₛ represents a time interval from time[i−1] to time[i]. The value of Tₛ is not particularly limited, and it is preferable to set an optimum value according to the purpose. Tₛ is usually set in a range of 0.01 s to 100 s.
α₁ to α₃₇ are each preferably determined to match actual IV characteristics or test results obtained by cyclic voltammetry (CV).
v₁ to v₃ represent reaction rates of formation and disappearance of each oxide or hydroxide (MO_{ad}, MOH_{ad}, MO_{sub}).
G₁ to G₃ represent the free energy of the reaction of v₁ to v₃.
θₒₓ₁[i−1], θₒₓ₂[i−1], and θₒₓ₃[i−1] are the coverages at the time[i−1], and have already been stored in the memory. θₒₓ₁[i−1], θₒₓ₂[i−1], and θₒₓ₃[i−1] can be calculated by sequential calculation when the initial values are known. As the initial value, a value at the time of the previous stop may be held and used as the initial value. In general, when the fuel cell is stopped, it is often retained at a low potential, and at that time, all the oxides are reduced. Therefore, the initial value after the fuel cell is stopped may be θₒₓ₁=θₒₓ₂=θₒₓ₃=0.

Therefore, when the V_{cat}[i] is acquired, the θ_{act}[i] can be calculated from formula (3) or (4).

In the formula (4), the θ_{act}[i] is calculated by subtracting, from the total surface (α₁), the products obtained by multiplying respective coverages by coefficients (α₂ to α₄). The θₒₓ₁[i] represents a coverage of hydroxide due to one-electron reaction. θₒₓ₂[i] and θₒₓ₃[i] each represent a coverage of the oxide due to the two-electron reaction. Assuming that one platinum surface site is consumed per one electron reaction, the following equations: α₁=1, α₂=1, α₃=2, and α₄=2 hold. In actual use, since the platinum surface is not uniform, α₁ to α₄ are determined to match the test results.

However, the formula (4) does not consider that the surface oxide species (coverages θₒₓ₁[i] and θₒₓ₂[i]) and the inside oxide species (coverage θₒₓ₃[i]) generate at the same platinum site, and in such a case, there is a concern that the θ_{act}[i] may be underestimated. For example, in a case where V_{cat}[i] continues to be high, θₒₓ₁[i], θₒₓ₂[i], and θₒₓ₃[i] each increase, so that the above problem is remarkable, and there is a concern about a decrease in accuracy.

On the other hand, the formula (3) has an advantage that estimation can be performed with high accuracy even in the above case by taking a ratio between the surface oxide species and the inside oxide species. In other cases, on the other hand, there is a concern that the accuracy of the formula (3) may be lower than that of the formula (4).

### [1.3. Third Means]

The third means is a means configured to calculate the electrode catalyst surface area A_{ECS}[i] at the time[i] and the activity SA[i] per surface area of the noble metal-based catalyst particles at the time[i] using the V[i], the V_{cat}[i], and/or the integration time of power generation of the polymer electrolyte fuel cell and store the A_{ECS}[i] and the SA[i] in a memory.

### [1.3.1. Calculation of Electrode Catalyst Surface Area A_{ECS}[i]]

The “electrode catalyst surface area A_{ECS}[i]” refers to the electrochemically effective surface area of the noble metal-based catalyst particles at the time[i]. There are various methods for calculating the A_{ESC}[i]. In the present invention, the method of calculating the A_{ECS}[i] is not particularly limited, and an optimal method can be used according to the purpose. The calculated A_{ECS}[i] is stored in the memory.

The third means preferably includes a means configured to calculate the A_{ECS}[i] using the following formulas (5), (6), and/or (7). Any one of these may be used for calculating the A_{ECS}[i], or these may be used depending on the purpose.

$$\begin{matrix}[ Math . 4 ] & \\ {A}_{E C S} [ i ] = {A}_{ECS 0} - {B}_{1} \times {\sum }_{0}^{i} {T}_{S} & ( 5 )\end{matrix}$$

$${A}_{E C S} [ i ] = {A}_{ECS 0} - {\sum }_{0}^{i} \{ {T}_{S} \times {θ}_{a c t} [ i ] \times exp ( {D}_{1} \times ( {D}_{2} - {V}_{c a t} [ i ] ) ) \} \qquad ( 6 )$$

$${A}_{E C S} [ i ] = {A}_{ECS 0} - {\sum }_{0}^{i} \{ {T}_{S} \times {θ}_{a c t} [ i ] \times exp ( {D}_{3} \times ( {D}_{4} - V [ i ] ) ) \} \qquad ( 7 )$$

wherein,
A_{ECS0} is an initial value (constant) of the electrode catalyst surface area,
Tₛ is a calculation step width, and
B₁, D₁, D₂, D₃, and D₄ are fitting coefficients.

It is preferable that each of the A_{ECS0}, B₁, D₁, D₂, D₃, and D₄ is set so as to be compatible with a result of another power generation test performed in advance.

The formula (5) is a calculation expression for calculating the A_{ESC}[i] using the integration time (=ΣTₛ) of power generation of the polymer electrolyte fuel cell. In general, as the integration time of power generation of the fuel cell is longer, the number of repetitions of dissolution and reprecipitation of the catalyst particles increases, so that the A_{ECS}[i] monotonously decreases with the integration time. The formula (5) is an approximate expression in which such a change in A_{ECS}[i] is approximated by a linear function of the integration time. The formula (5) has an advantage that the calculation cost can be reduced although the estimation accuracy is low.

The formula (6) is a calculation expression for calculating the A_{ECS}[i] using the Tₛ, the θ_{act}[i], and the V_{cat}[i]. The formula (6) calculates the A_{ECS}[i] more precisely than the formula (5). In the formula (5), the A_{ECS}[i] is calculated on the assumption that dissolution/precipitation of the catalyst component occurs regardless of the V_{cat}[i], but the A_{ECS}[i] should originally depend on the V_{cat}[i].

In the formula (6), focusing on the phenomenon during dissolution, it is assumed that the elution amount is proportional to an exponential function with e as the base and V_{cat}[i] as the exponent. In addition, it is assumed that the dissolution phenomenon of the catalyst component occurs only in a region not covered with the oxide, and the above-described exponential function is multiplied by the θ_{act}[i]. On the other hand, the formula (6) has a disadvantage that the calculation cost is higher than that of the formula (5).

The formula (7) is a calculation expression for calculating the A_{ECS}[i] using the Tₛ, the θ_{act}[i], and the V[i]. The formula (7) has a merit that the measurement of the high frequency impedance R[i] necessary for calculating the V_{cat}[i] represented by the formula (2) is unnecessary, but has a disadvantage that the accuracy decreases accordingly.

All or part of the calculation of the A_{ECS}[i] using the formulas (6) to (7) may be replaced with calculation using a more detailed physical model as described in Reference Literature 1. The use of the calculation in the physical model can improve the estimation accuracy of the A_{ECS}[i].

Here, the “physical model” refers to a model capable of estimating time dependent deterioration of an electrode catalyst using a theoretical formula and estimating the A_{ECS}[i] (and SA[i] to be described later) based on the estimated time dependent deterioration. For example, Reference Literature 2 discloses a method of predicting deterioration of an electrode catalyst of a fuel cell. The A_{ECS}[i] at time[i] can be estimated using the method described in the Reference Literature 2. Such a physical model is also reported in Reference Literature 3 below.
[Reference Literature 1] Darling, R. M. and J. P. Meyers (2003), “Kinetic model of platinum dissolution in PEMFCs,” Journal of the Electrochemical Society 150 (11): A1523-A1527
[Reference Literature 2] JP 2010-236989 A
[Reference Literature 3] Sekine, S. (2020), “PtCo Catalyst Dissolution and Oxidation Modeling for Durability Improvement of Automotive Fuel Cell,” ECS transaction

### [1.3.2. Calculation of Activity SA[i]]

The “activity SA[i]” refers to activity per surface area of the noble metal-based catalyst particles at time[i]. There are various methods for calculating SA[i]. In the present invention, the calculation formula of the SA[i] is not particularly limited, and an optimum calculation formula can be used according to the purpose. The calculated SA[i] is stored in the memory.

The third means preferably includes a means configured to calculate the SA[i] using the following formula (8) and/or formula (9). Any one of these may be used for calculating the SA[i], or these may be used depending on the purpose.

$$\begin{matrix}[ Math . 5 ] & \\ SA [ i ] = S {A}_{0} - {B}_{2} \times {\sum }_{0}^{i} {T}_{S} & ( 8 )\end{matrix}$$

$$SA [ i ] = S {A}_{0} \times {B}_{3} \times \frac{{A}_{E C S} [ i ]}{{A}_{ECS 0}} \qquad ( 9 )$$

wherein,
SA₀ is an initial value (constant) of activity per surface area of the noble metal-based catalyst particles,
A_{ECS0} is an initial value (constant) of the electrode catalyst surface area,
Tₛ is a calculation step width, and
B₂ and B₃ are fitting coefficients.

It is preferable that SA₀, B₂, and B₃ are set so as to be compatible with the test result by performing another power generation test in advance.

The formula (8) is a calculation expression for calculating the SA[i] using the integration time (=ΣTₛ) of power generation of the polymer electrolyte fuel cell. In general, as the integration time of power generation of the fuel cell is longer, the number of repetitions of dissolution and reprecipitation of the catalyst particles increases, and thus the SA[i] monotonically decreases with the integration time. The formula (8) is an approximate expression in which such a change in SA[i] is approximated by a linear function of the integration time. The formula (8) has an advantage that the calculation cost can be reduced although the estimation accuracy is low.

The formula (9) is a calculation expression for calculating the SA[i] using the A_{ECS}[i]. The formula (9) calculates the SA[i] assuming that the SA[i] is proportional to the retention of platinum surface area (A_{ECS}[i]/A_{ECS0}). The formula (9) has an advantage that accuracy is improved as compared with the formula (8), but has a disadvantage that calculation cost increases.

As in the calculation of the A_{ECS}[i], all or part of the calculation of the SA[i] using the formulas (8) to (9) may be replaced with calculation with a more detailed physical model. The use of the calculation in the physical model can improve the estimation accuracy of the SA[i]. Since the details of the physical model are as described above, the description thereof will be omitted.

### [1.4. Fourth Means]

The fourth means is a means configured to calculate the estimated value IVₑₛₜ[i] of the IV characteristics representing the relationship between the I[i] and the estimated voltage Vₑₛₜ[i] of the polymer electrolyte fuel cell using the θ_{act}[i], the A_{ECS}[i], and the SA[i] and store the IVₑₛₜ[i] in the memory.

There are various methods for calculating the Vₑₛₜ[i]. In the present invention, a method of calculating the Vₑₛₜ[i] is not particularly limited, and an optimal method can be selected according to a purpose. The calculated relationship between Vₑₛₜ[i] and I[i], that is, the IVₑₛₜ[i] is stored in the memory.

The fourth means may include a means configured to calculate the IVₑₛₜ[i] expressed by the following formula (10).

Strictly speaking, the Vₑₛₜ[i] also depends on a temperature T_{FC}[i], a high frequency impedance R[i], a cathode air pressure P_{ca}[i], and a cathode air stoichiometric ST_{ca}[i] of the polymer electrolyte fuel cell at time[i]. The formula (10) is an approximate expression of the Vₑₛₜ[i] in which these are regarded as constants.

The formula (10) has lower estimation accuracy than the formula (11) described later, but has an advantage that the calculation cost can be reduced.

$$\begin{matrix}[ Math . 6 ] & \\ & ( 10 )\end{matrix}$$

$${V}_{e s t} [ i ] = {V}_{O C V} - {C}_{1} \times log ( \frac{I [ i ]}{{I}_{0} [ i ]} ) - {C}_{2} \times I [ i ] - {C}_{3} \times log ( \frac{{C}_{4}}{{C}_{5} - {C}_{6 \times } {R}_{g a s} [ i ] \times I [ i ]} )$$

$${I}_{0} [ i ] = {C}_{7} \times \frac{{A}_{E C S} [ i ]}{{A}_{ECS 0}} \times \frac{S A [ i ]}{S {A}_{0}} \times {θ}_{a c t} [ i ]$$

$${R}_{g a s} [ i ] = {C}_{8} + {C}_{9} \times \frac{{A}_{E C S} [ i ]}{{A}_{ECS 0}}$$

wherein,
V_{ocv} is an open circuit electromotive voltage of the polymer electrolyte fuel cell,
I₀[i] is an exchange current density,
R_{gas}[i] is a gas diffusion resistance,
A_{ECS0} is an initial value (constant) of the electrode catalyst surface area,
SA₀ is an initial value (constant) of activity per surface area of the noble metal-based catalyst particles, and
C₁ to C₉ are fitting coefficients.

It is preferable that C₁ to C₉ are set so as to be compatible with the test result obtained by performing another power generation test in advance.

In the formula (10), the first term on the right side represents an open circuit electromotive voltage, the second term on the right side represents an activation overvoltage, the third term on the right side represents a concentration overvoltage, and the fourth term on the right side represents a resistance overvoltage.

In addition, in the formula (10), the “exchange current density I₀[i]” is a current density when oxidation and reduction phenomena are in an equilibrium state, and indicates the ease of a power generation reaction.

Furthermore, in the formula (10), the “gas diffusion resistance R_{gas}[i]” indicates the difficulty of diffusion of fuel/oxidizing gas.

The fourth means may include a means configured to calculate the IVₑₛₜ[i] expressed by the following formula (11) instead of or in addition to the formula (10). For the calculation of the IVₑₛₜ[i], either the formula (10) or the formula (11) may be used, or one of these may be used depending on the purpose.

In the formula (11), T_{FC}[i], R[i], P_{ca}[i], and ST_{ca}[i] are considered in calculating the Vₑₛₜ[i]. Therefore, although the calculation cost of the formula (11) is increased as compared with that of the formula (10), the estimation accuracy is improved.

$$\begin{matrix}[ Math . 7 ] & \\ {V}_{e s t} [ i ] = {V}_{O C V} - {C}_{10} \times {T}_{f c} [ i ] \times log ( \frac{I [ i ]}{{I}_{0} [ i ]} ) - {C}_{11} \times {T}_{f c} [ i ] \times log ( \frac{{C}_{4}}{{C}_{{O}_{2}} [ i ] - {C}_{6 \times } {R}_{g a s} [ i ] \times I [ i ]} ) - {C}_{12} \times R [ i ] I [ i ] & ( 11 )\end{matrix}$$

$${I}_{0} [ i ] = {C}_{7} \times \frac{{A}_{E C S} [ i ]}{{A}_{ECS 0}} \times \frac{S A [ i ]}{S {A}_{0}} \times {θ}_{act} [ i ] \times {e}^{\frac{{C}_{13}}{{T}_{f c} [ i ]}}$$

$${R}_{g a s} [ i ] = \frac{{P}_{c a} [ i ]}{{C}_{14}} + {C}_{9} \times \frac{{A}_{E C S} [ i ]}{{A}_{ECS 0}}$$

$${C}_{{O}_{2}} [ i ] = {C}_{15} \times \frac{{P}_{c a} [ i ]}{{T}_{f c} [ i ]} \times \frac{{c}_{16} + \frac{S {T}_{c a} [ i ] - 1}{{ST}_{c a} [ i ]}}{2}$$

wherein,
V_{ocv} is an open circuit electromotive voltage of the polymer electrolyte fuel cell,
I₀[i] is an exchange current density,
R_{gas}[i] is a gas diffusion resistance,
A_{ECS0} is an initial value (constant) of the electrode catalyst surface area,
SA₀ is an initial value (constant) of activity per surface area of the noble metal-based catalyst particles, and
C₄, C₆, C₇, and C₉, and C₁₀ to C₁₆ are fitting coefficients.

It is preferable that C₄ to C₁₆ are set so as to be compatible with the test result obtained by performing another power generation test in advance.

### [1.5. Fifth Means]

The fuel cell performance estimation device according to the present invention may further include
(E) a fifth means configured to determine a failure of the polymer electrolyte fuel cell using the IVₑₛₜ[i].

The IVₑₛₜ[i] obtained as described above represents current-voltage characteristics in which the influence of a steady voltage reduction due to catalyst deterioration and the influence of a temporary voltage fluctuation due to the formation/reduction of an oxide film on the catalyst surface are excluded (that is, the estimation value of the current-voltage characteristics in a case where it is assumed that no failure has occurred). Therefore, when the IVₑₛₜ[i] is used, the presence or absence of a failure can be accurately determined.

There are various failure determination methods using the IVₑₛₜ[i]. In the present invention, a failure determination method using the IVₑₛₜ[i] is not particularly limited, and an optimum method can be selected according to a purpose. Specific examples of the failure determination method include the following methods.

### [1.5.1. Comparison of V[i] and Vₑₛₜ[i]: Means A]

The fifth means may include a means A configured to compare the V[i] at the time[i] with the Vₑₛₜ[i] obtained by substituting the I[i] into the IVₑₛₜ[i], and determines whether the polymer electrolyte fuel cell has failed.

Substituting the I[i] into the IVₑₛₜ[i] results in the Vₑₛₜ[i]. When the polymer electrolyte fuel cell has not failed, the Vₑₛₜ[i] ideally matches the V[i]. Therefore, when the Vₑₛₜ[i] greatly deviates from the V[i], it can be estimated that a failure has occurred.

The means A configured to compare the V[i] with the Vₑₛₜ[i] is not particularly limited, and an optimal means can be selected according to a purpose. Examples of the means A include
(a) a means A1 configured to determine that the fuel cell has failed when an absolute value of a difference between the V[i] and the Vₑₛₜ[i] exceeds a first threshold value ε₁ or is equal to or greater than the ε₁,
(b) a means A2 configured to determine that the fuel cell has failed when a ratio of the V[i] to the Vₑₛₜ[i] (=V[i]/Vₑₛₜ[i]) is less than a second threshold value ε₂ or is equal to or less than the ε₂,
(c) a means A3 configured to determine that the fuel cell has failed when a ratio (=(Vₑₛₜ[i]−V[i])/V[i]) of a difference between the Vₑₛₜ[i] and the V[i] to the V[i] exceeds a third threshold value ε₃ or is equal to or greater than the ε₃, and
the like.

The fifth means may include any one of these means, or may include two or more means. The values of ε₁ to ε₃ are not particularly limited, and an optimum value can be selected according to the purpose.

[1.5.2. Comparison between Vₘ[T] and V_{m_est}[T]: Means B]

The fifth means may include a means B configured to calculate the average voltage Vₘ[T] and the average estimated voltage V_{m_est}[T] during a certain time interval ΔT using the V[i] and the Vₑₛₜ[i], respectively, compare the calculated Vₘ[T] with the calculated V_{m_est}[T], and determine whether the polymer electrolyte fuel cell has failed.

When the voltage V[i] is known, the average voltage Vₘ[T] can be calculated using the voltage V[i]. Similarly, when the estimated voltage Vₑₛₜ[i] is known, the average estimated voltage V_{m_est}[T] can be calculated using the estimated voltage Vₑₛₜ[i]. When the polymer electrolyte fuel cell has not failed, the V_{m_est}[T] also ideally matches the Vₘ[T]. Therefore, when the V_{m_est}[T] greatly deviates from the Vₘ[T], it can be estimated that a failure has occurred. In the means B using the average value, transient voltage fluctuations due to fluctuations in operating conditions are likely to be offset. Therefore, the means B has higher estimation accuracy than the means A using the estimated value at a certain time[i].

Here, the “average voltage Vₘ[T]” refers to an average value of voltages obtained by extracting a V[i] when the I[i] is a reference current Is during a certain time interval ΔT and averaging these.

The “average estimated voltage V_{m_est}[T]” refers to an average value of estimated voltages obtained by extracting a Vₑₛₜ[i] when the I[i] is an Iₛ during ΔT and averaging these.

The “time interval ΔT” refers to a time interval for extracting data necessary for calculating the Vₘ[T] and the V_{m_est}[T].

The “reference current Iₛ” refers to a current serving as a reference when the V[i] and the Vₑₛₜ[i] are extracted (that is, a current serving as a reference in calculating the average voltage Vₘ[T] and the average estimated voltage V_{m_est}[T]).

A method of calculating the Vₘ[T] and the V_{m_est}[T] is not particularly limited, and it is preferable to select an optimum method according to a purpose.

The means B preferably includes
a means configured to calculate the Vₘ[T] using the following formula (12) and
a means configured to calculate the V_{m_est}[T] using the following formula (13).

$$\begin{matrix}[ Math . 8 ] & \\ {V}_{m} [ T ] = \frac{{\sum }_{i = T}^{T + Δ T} \{ V [ i ] \times ( I [ i ] == {I}_{S} ) \}}{{\sum }_{i = T}^{T + Δ T} ( I [ i ] == {I}_{S} )} & ( 12 )\end{matrix}$$

$${V}_{m\_est} [ T ] = \frac{{\sum }_{i = T}^{T + Δ T} \{ {V}_{est} [ i ] \times ( I [ i ] == {I}_{S} ) \}}{{\sum }_{i = T}^{T + Δ T} ( I [ i ] == {I}_{S} )} \qquad ( 13 )$$

$$( I [ i ] == {I}_{S} ) = \{ \begin{matrix}1 & ( I [ i ] = {I}_{S} ) \\ 0 & ( I [ i ] \neq {I}_{S} )\end{matrix}$$

wherein, Iₛ is a reference current when calculating the average voltage Vₘ[T] and the average estimated voltage V_{m_est}[T].

ΔT is not particularly limited, and an optimal time interval can be selected according to a purpose. In general, if ΔT is too short, erroneous determination may occur due to the influence of noise or the like on the value acquisition unit. Therefore, ΔT is preferably twice or more the step width Tₛ of the calculation. ΔT is more preferably 5 times or more Tₛ, and still more preferably 10 times or more Tₛ.

On the other hand, when ΔT is too long, the time until the failure is determined is long. Therefore, ΔT is preferably 10,000 times or less of Tₛ. ΔT is more preferably 1000 times or less of Tₛ, and still more preferably 100 times or less of Tₛ.

The means B configured to compare the Vₘ[T] and the V_{m_est}[T] is not particularly limited, and an optimal means can be selected according to a purpose. Examples of the means B include
(a) a means B₁ configured to determine that the fuel cell has failed when an absolute value of a difference between the Vₘ[T] and the V_{m_est}[T] exceeds a fourth threshold value ε₄ or is equal to or greater than the ε₄,
(b) a means B₂ configured to determine that the fuel cell has failed when a ratio (=Vₘ[T]/V_{m_est}[T]) of the Vₘ[T] to the V_{m_est}[T] is less than the fifth threshold value ε₅ or is equal to or less than the ε₅,
(c) a means B₃ configured to determine that the fuel cell has failed when a ratio (=(V_{m_est}[T]−Vₘ[T])/Vₘ[T]) of a difference between the V_{m_est}[T] and the Vₘ[T] to the Vₘ[T] exceeds a sixth threshold value ε₆ or is equal to or greater than the ε₆, and
the like.

The fifth means may include any one of these means, or may include two or more means. The values of ε₄ to ε₆ are not particularly limited, and an optimum value can be selected according to the purpose.

### 2. Fuel Cell Performance Estimation Method

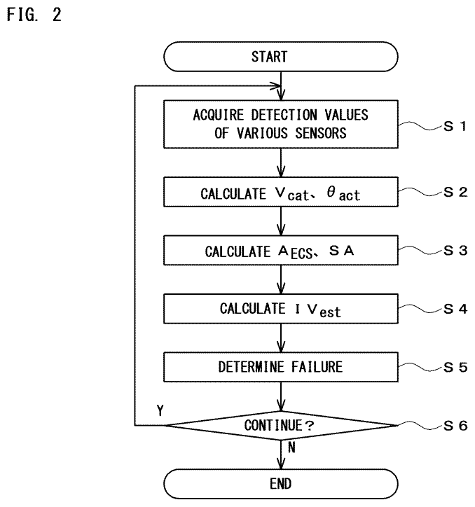

FIG. 2 illustrates a flowchart for calculating the estimated value IVₑₛₜ[i] of the current-voltage characteristics and performing failure determination.

First, in step 1 (hereinafter, also simply referred to as “S1”), at least a voltage V[i] and a current I[i] of the polymer electrolyte fuel cell at the time[i] are sequentially acquired using various sensors, and the V[i] and the I[i] are stored in a memory (first means). In this case, in addition to the V[i] and the I[i], the high frequency impedance R[i] of the polymer electrolyte fuel cell at the time[i] may be further acquired. Furthermore, in addition to these, the temperature T_{FC}[i], the cathode air pressure P_{ca}[i], and the cathode air stoichiometric ST_{ca}[i] may be further acquired.

Next, the process proceeds to S2. In S2, the catalyst potential V_{cat}[i] of the cathode of the polymer electrolyte fuel cell at the time[i] is calculated using at least the V[i]. Next, the effective surface utilization factor θ_{act}[i] of the noble metal-based catalyst particles contained in the polymer electrolyte fuel cell at the time[i] is calculated using the V_{cat}[i]. Furthermore, the obtained V_{cat}[i] and θ_{act}[i] are stored in the memory (second means). Details of the methods of calculating the V_{cat}[i] and the θ_{act}[i] are as described above, and thus the description thereof will be omitted.

Next, the process proceeds to S3. In S3, the electrode catalyst surface area A_{ECS}[i] at the time[i] and the activity SA[i] per surface area of the noble metal-based catalyst particles at the time[i] are calculated using the V[i], the V_{cat}[i], and/or the integration time of power generation of the polymer electrolyte fuel cell, and the A_{ECS}[i] and the SA[i] are stored in the memory (third means). Details of the methods of calculating the A_{ECS}[i] and the SA[i] are as described above, and thus the description thereof will be omitted.

Next, the process proceeds to S4. In S4, the estimated value IVₑₛₜ[i] of the IV characteristics representing the relationship between the I[i] and the estimated voltage Vₑₛₜ[i] of the polymer electrolyte fuel cell is calculated using the θ_{act}[i], the A_{ECS}[i], and the SA[i], and the IVₑₛₜ[i] is stored in the memory (fourth means). Details of the method of calculating the IVₑₛₜ[i] are as described above, and thus the description thereof will be omitted.

Next, the process proceeds to S5. In S5, failure determination of the polymer electrolyte fuel cell is performed using the IVₑₛₜ[i] (fifth means). Details of the failure determination method are as described above, and thus description thereof is omitted. When only the calculation of IVₑₛₜ[i] is performed, S5 can be omitted.

Next, the process proceeds to S6. In S6, it is determined whether to continue the control. When the control is continued (S6: YES), the process returns to S1, and the above-described steps S1 to S6 are repeated. On the other hand, when the control is not continued (S6: NO), the control is terminated.

### 3. Effect

### [3.1. Current-Voltage Characteristics at the Normal Time and at the Time of Failure]

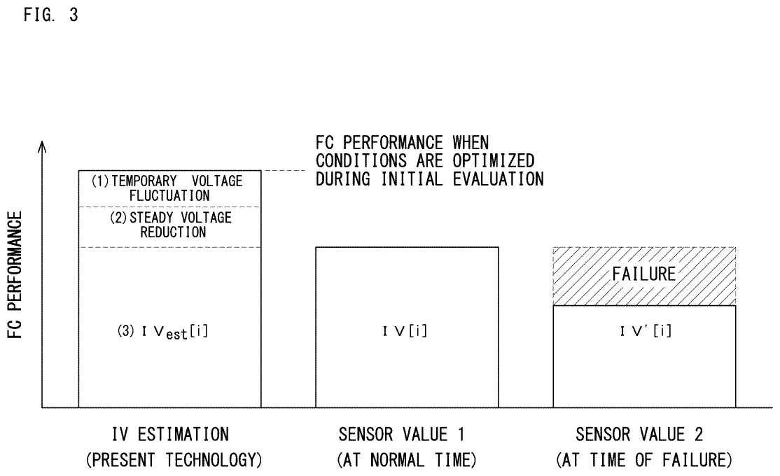

FIG. 3 illustrates a relationship among the estimated value IVₑₛₜ[i] of the current-voltage characteristics, the sensor value 1 (the measured value IV[i] of the current-voltage characteristics at the normal time), and the sensor value 2 (the measured value IV′[i] of the current-voltage characteristics at the time of failure).

When power is generated under a specific power generation condition immediately after completion of the fuel cell, the performance of the fuel cell (performance at the time of initial evaluation) shows a maximum value. However, when the fuel cell is operated for a long time, the catalyst particles are repeatedly dissolved and reprecipitated, and thus the performance of the fuel cell decreases as the integration time of power generation increases. In addition, when the fuel cell is actually operated, since the power generation condition changes from moment to moment during the operation, the performance of the fuel cell may temporarily fluctuate although the catalyst particles are not deteriorated. Therefore, the sensor value 1 at the time[i] (the measured value IV[i] of the current-voltage characteristics at the normal time) is a value obtained by subtracting the steady voltage reduction and the temporary voltage fluctuation from the initial performance.

On the other hand, when the fuel cell fails, the sensor value 2 at the time[i] (the measured value IV′[i] of the current-voltage characteristics at the time of failure) is a value obtained by subtracting the voltage reduction due to the failure in addition to the steady voltage reduction and the temporary voltage fluctuation from the initial performance. Therefore, by monitoring the temporal change in the IV[i], it is ideally possible to determine the presence or absence of a failure.

However, in practice, even when a voltage reduction due to a failure or a steady voltage reduction does not occur, a temporary voltage fluctuation may increase. In such a case, when the failure determination is performed based on the temporal change in the IV[i], the erroneous determination may be performed.

On the other hand, when the estimated value of the steady state voltage reduction and the estimated value of the temporary voltage fluctuation can be calculated using various methods, the estimated value IVₑₛₜ[i] of the current-voltage characteristics at the time[i] can be calculated by subtracting these values from the initial performance. When no failure occurs, ideally the IVₑₛₜ[i] matches the IV[i]. On the other hand, when a failure occurs, the IVₑₛₜ[i] greatly deviates from the IV[i]. Therefore, by comparing the IV[i] with the IVₑₛₜ[i], the presence or absence of a failure can be accurately determined.

### [3.2. Temporary Voltage Fluctuation]

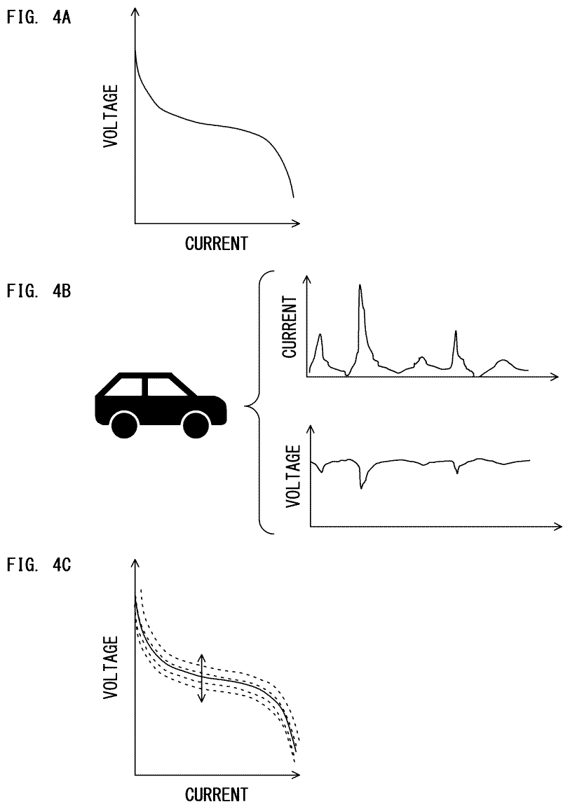

FIG. 4A illustrates a schematic diagram of current-voltage characteristics when power is generated under a specific power generation condition. FIG. 4B illustrates a schematic diagram of current fluctuation and voltage fluctuation during operation of a fuel cell (FC) vehicle. FIG. 4C illustrates a schematic diagram of measured values of the current-voltage characteristics obtained by making the relationship between the current and the voltage shown in FIG. 4B a scatter diagram.

The “performance of the fuel cell” corresponds to, for example, a voltage value for an any current (reference current Iₛ) in the current-voltage characteristics (IV characteristics) illustrated in FIG. 4A. This IV characteristics vary depending on the history during power generation. For example, consider driving with the FC vehicle illustrated in FIG. 4B. In this case, since the power generation amount of the fuel cell is not constant, the current and the voltage fluctuate with time. When the relationship between the current and the voltage at this time is illustrated in a scatter diagram, the IV characteristics illustrated in FIG. 4C are obtained. This is a curve having a distribution unlike the IV characteristics of FIG. 4A that can be drawn with one line. This distribution corresponds to “temporary voltage fluctuation”. This temporary fluctuation component makes it difficult to perform IV estimation with high accuracy. For example, when failure determination is performed, it may be difficult to differentiate between voltage reduction due to failure and temporary voltage fluctuation.

Factors that temporarily change the performance of the fuel cell include the following factors.
(a) Temporary voltage fluctuations due to temporary variations in the effective area of the catalyst or catalytic activity.
(b) Temporary voltage fluctuation caused by a transient change in power generation conditions such as a change in a gas supply state (flow rate, pressure, humidity) and temperature.

Among these, (b) can be offset to some extent by using an average value averaged during a certain time interval ΔT at the time of determination. However, in (a), there has been no effective sensing method in the related art, and the state at the present time changes depending on the use history so far, so that it has been difficult to estimate the temporary voltage fluctuation.

### [3.3. Calculation of IVₑₛₜ[i]]

The inventors of the present application have found that the above phenomenon (a) can be expressed based on the estimated values θₒₓ₁, θₒₓ₂, and θₒₓ₃ of oxide on the surface of and inside the catalyst based on the reaction rate equation and the surface utilization factor fact calculated using the estimated values θₒₓ₁, θₒₓ₂, and θₒₓ₃. As a result, it is possible to determine whether a voltage reduction occurs due to a failure or a temporary decrease in performance, and it is possible to detect a failure with higher accuracy than before.

That is, when the voltage V[i] and the current I[i] of the polymer electrolyte fuel cell at the time[i] are sequentially acquired, the catalyst potential V_{cat}[i] of the cathode can be calculated using at least the V[i]. When the V_{cat}[i] is known, the effective surface utilization factor θ_{act}[i] of the noble metal-based catalyst particles can be calculated. The θ_{act}[i] correlates with temporary voltage fluctuation caused by formation/reduction of an oxide film.

In addition, when the V[i], the V_{cat}[i], or the integration time of power generation is known, the electrode catalyst surface area A_{ECS}[i] at the time[i] and the activity SA[i] per surface area of the noble metal-based catalyst particles at the time[i] can be calculated using these. Both A_{ECS}[i] and SA[i] are correlated with a steady voltage reduction due to catalyst deterioration.

Further, using the acquired I[i] and the calculated θ_{act}[i], A_{ECS}[i], and SA[i], the estimated value IVₑₛₜ[i] of the IV characteristics of the polymer electrolyte fuel cell at time[i] can be calculated. The IVₑₛₜ[i] thus obtained represents the current-voltage characteristics in which the influence of a steady voltage reduction due to catalyst deterioration and the influence of a temporary voltage fluctuation due to the formation/reduction of an oxide film on the catalyst surface are excluded (that is, the estimated value of the current-voltage characteristics in a case where it is assumed that no failure has occurred). Therefore, by comparing the actual current-voltage characteristics IV[i] of the polymer electrolyte fuel cell at the time[i] with IVₑₛₜ[i], the presence or absence of the failure can be accurately determined.

### [3.4. Failure Determination]

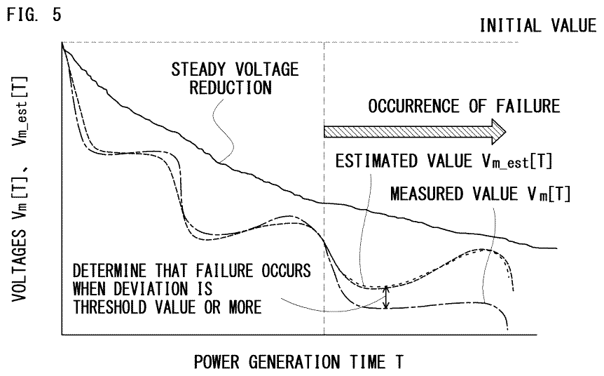

FIG. 5 illustrates a schematic diagram of failure determination using the estimated value IVₑₛₜ[i] of the current-voltage characteristics. As illustrated in FIG. 5, the Vₑₛₜ[i] or its average value V_{m_est}[T] calculated by the method according to the present invention substantially matches the V[i] or its average value Vₘ[T] until a failure occurs. On the other hand, even when a failure occurs, the voltage reduction due to the failure is not reflected in the Vₑₛₜ[i] or its average value V_{m_est}[T]. Therefore, after the failure occurs, the Vₑₛₜ[i] or its average value V_{m_est}[T] greatly deviates from the V[i] or its average value Vₘ[T]. Therefore, for example, when the difference between the two exceeds a certain threshold value, it can be determined that a failure has occurred.

Although the embodiments of the present invention have been described in detail above, the present invention is not limited to the above embodiments at all, and various modifications can be made without departing from the gist of the present invention.

### INDUSTRIAL APPLICABILITY

The fuel cell performance estimation device according to the present invention can be used for performance estimation of a fuel cell vehicle at a current time and failure determination of a fuel cell.

1. A fuel cell performance estimation device comprising:
(A) a first means configured to sequentially acquire at least a voltage V[i] and a current I[i] of a polymer electrolyte fuel cell at a time[i] and store the V[i] and the I[i] in a memory;
(B) a second means configured to calculate a catalyst potential V_{cat}[i] of a cathode of the polymer electrolyte fuel cell at the time[i] using at least the V[i],
calculate an effective surface utilization factor θ_{act}[i] of noble metal-based catalyst particles contained in the polymer electrolyte fuel cell at the time[i] using the V_{cat}[i], and
store the V_{cat}[i] and the θ_{act}[i] in the memory;
(C) a third means configured to calculate an electrode catalyst surface area A_{ECS}[i] at the time[i] and an activity SA[i] per surface area of the noble metal-based catalyst particles at the time[i] using the V[i], the V_{cat}[i], and/or an integration time of power generation of the polymer electrolyte fuel cell and store the A_{ECS}[i] and the SA[i] in the memory; and
(D) a fourth means configured to calculate an estimated value IVₑₛₜ[i] of IV characteristics representing a relationship between the I[i] and an estimated voltage Vₑₛₜ[i] of the polymer electrolyte fuel cell using the θ_{act}[i], the A_{ECS}[i], and the SA[i] and store the IVₑₛₜ[i] in the memory.

2. The fuel cell performance estimation device according to claim 1, wherein the second means includes a means configured to calculate the V_{cat}[i] using the following formula (1):
$$\begin{matrix}[ Math . 1 ] & \\ {V}_{c a t} [ i ] = \frac{V [ i ]}{{N}_{c e l l}} & ( 1 )\end{matrix}$$
wherein, N_{cell} is the number of stacked cells of the polymer electrolyte fuel cell.

3. The fuel cell performance estimation device according to claim 1, wherein the first means further includes a means configured to sequentially acquire a high frequency impedance R[i] of the polymer electrolyte fuel cell at the time[i] and store the R[i] in the memory, and wherein the second means includes a means configured to calculate the V_{cat}[i] using the following formula (2):
$$\begin{matrix}[ Math . 2 ] & \\ {V}_{c a t} [ i ] = \frac{V [ i ]}{{N}_{c e l l}} + ( \frac{I [ i ]}{{A}_{c e t l}} \times \frac{R [ i ] \times {A}_{c e l l}}{{N}_{c e l l}} ) & ( 2 )\end{matrix}$$
wherein,
N_{cell} is the number of stacked cells of the polymer electrolyte fuel cell, and
A_{cell} is an area of the cell.

4. The fuel cell performance estimation device according to claim 1, wherein the second means includes a means configured to calculate the θ_{act}[i] using the following formula (3) and/or formula (4):
$$\begin{matrix}[ Math . 3 ] & \\ {θ}_{act} [ i ] = {α}_{1} - {α}_{2} ( {θ}_{ox 1} [ i ] + {θ}_{o x 2} [ i ] ) - {α}_{3} \frac{{θ}_{o x 3} [ i ]}{( {θ}_{o x 1} [ i ] + {θ}_{o x 2} [ i ] )} & ( 3 )\end{matrix}$$
$${θ}_{a c t} [ i ] = {α}_{1} - {α}_{2} \times {θ}_{o x 1} [ i ] - {α}_{3} \times {θ}_{ox 2} [ i ] - {α}_{4} \times {θ}_{o x 3} [ i ] \qquad ( 4 )$$
$${θ}_{o x 1} [ i ] = {θ}_{o x 1} [ i - 1 ] + {T}_{s} \times \frac{{v}_{1} - {v}_{2}}{Γ}$$
$${θ}_{o x 2} [ i ] = {θ}_{o x 2} [ i - 1 ] + {T}_{s} \times \frac{{v}_{2} - {v}_{3}}{Γ}$$
$${θ}_{o x 3} [ i ] = {θ}_{o x 3} [ i - 1 ] + {T}_{s} \times \frac{{v}_{3}}{Γ}$$
$${v}_{1} = {α}_{11} \text{} \{ ( 1 - {θ}_{o x 1} [ i - 1 ] - {θ}_{o x 2} [ i - 1 ] ) \times exp ( {α}_{12} \times {G}_{1} ) - {θ}_{o x 1} [ i - 1 ] \times exp ( - {α}_{13} \times {G}_{1} ) \}$$
$${v}_{2} = {α}_{21} \{ {θ}_{o x 1} [ i - 1 ] \times exp ( {α}_{22} \times {G}_{2} ) - {θ}_{o x 2} [ i - 1 ] \times exp ( - {α}_{23} \times {G}_{2} ) \}$$
$${v}_{3} = {α}_{31} \{ ( 1 - {θ}_{o x 3} [ i - 1 ] ) \times {θ}_{o x 2} [ i - 1 ] \times exp ( {α}_{32} \times {G}_{3} ) - {θ}_{o x 3} [ i - 1 ] \times ( 1 - {θ}_{o x 1} [ i - 1 ] - {θ}_{o x 2} [ i - 1 ] ) \times exp ( - {a}_{33} \times {G}_{3} ) \}$$
$${G}_{1} = {V}_{c a t} [ i ] - {α}_{14} - {α}_{15} \times {θ}_{o x 1} [ i - 1 ] - {α}_{16} \times {θ}_{o x 2} [ i - 1 ] - {α}_{17} \times {θ}_{o x 3} [ i - 1 ]$$
$${G}_{2} = {V}_{c a t} [ i ] - {α}_{24} - {α}_{25} \times {θ}_{o x 1} [ i - 1 ] - {α}_{26} \times {θ}_{o x 2} [ i - 1 ] - {α}_{27} \times {θ}_{0 x 3} [ i - 1 ]$$
$${G}_{3} = {V}_{c a t} [ i ] - {α}_{34} - {α}_{35} \times {θ}_{o x 1} [ i - 1 ] - {α}_{36} \times {θ}_{o x 2} [ i - 1 ] - {α}_{37} \times {θ}_{o x 3} [ i - 1 ]$$
wherein,
θₒₓ₁[i] is a coverage of the noble metal hydroxide adsorbed on the surface of the noble metal-based catalyst particles at the time[i],
θₒₓ₂[i] is a coverage of the noble metal oxide adsorbed on the surface of the noble metal-based catalyst particles at the time[i],
θₒₓ₃[i] is a coverage of the noble metal oxide present inside the noble metal-based catalyst particles at the time[i],
Γ is the maximum surface covering oxygen amount (constant) per unit surface area,
Tₛ is a calculation step width, and
α₁ to α₄, α₁₁ to α₁₇, α₂₁ to α₂₇, and α₃₁ to α₃₇ are fitting coefficients.

5. The fuel cell performance estimation device according to claim 1, wherein the third means includes a means configured to calculate the A_{ECS}[i] using the following formulas (5), (6), and/or (7):
$$\begin{matrix}[ Math . 4 ] & \\ {A}_{E C S} [ i ] = {A}_{ECS 0} - {B}_{1} \times {\sum }_{0}^{i} {T}_{S} & ( 5 )\end{matrix}$$
$${A}_{E C S} [ i ] = {A}_{ECS 0} - {\sum }_{0}^{i} \{ {T}_{S} \times {θ}_{a c t} [ i ] \times exp ( {D}_{1} \times ( {D}_{2} - {V}_{c a t} [ i ] ) ) \} \qquad ( 6 )$$
$${A}_{E C S} [ i ] = {A}_{ECS 0} - {\sum }_{0}^{i} \{ {T}_{S} \times {θ}_{a c t} [ i ] \times exp ( {D}_{3} \times ( {D}_{4} - V [ i ] ) ) \} \qquad ( 7 )$$
wherein,
A_{ECS0} is an initial value (constant) of the electrode catalyst surface area,
Tₛ is a calculation step width, and
B₁, D₁, D₂, D₃, and D₄ are fitting coefficients.

6. The fuel cell performance estimation device according to claim 1, wherein the third means includes a means configured to calculate the SA[i] using the following formula (8) and/or formula (9):
$$\begin{matrix}[ Math . 5 ] & \\ SA [ i ] = S {A}_{0} - {B}_{2} \times {\sum }_{0}^{i} {T}_{S} & ( 8 )\end{matrix}$$
$$SA [ i ] = S {A}_{0} \times {B}_{3} \times \frac{{A}_{E C S} [ i ]}{{A}_{ECS 0}} \qquad ( 9 )$$
wherein,
SA₀ is an initial value (constant) of activity per surface area of the noble metal-based catalyst particles,
A_{ECS0} is an initial value (constant) of the electrode catalyst surface area,
Tₛ is a calculation step width, and
B₂ and B₃ are fitting coefficients.

7. The fuel cell performance estimation device according to claim 1, wherein the fourth means includes a means configured to calculate the IVₑₛₜ[i] expressed by the following formula (10):
$$\begin{matrix}[ Math . 6 ] & \\ & ( 10 )\end{matrix}$$
$${V}_{e s t} [ i ] = {V}_{O C V} - {C}_{1} \times log ( \frac{I [ i ]}{{I}_{0} [ i ]} ) - {C}_{2} \times I [ i ] - {C}_{3} \times log ( \frac{{C}_{4}}{{C}_{5} - {C}_{6 \times } {R}_{g a s} [ i ] \times I [ i ]} )$$
$${I}_{0} [ i ] = {C}_{7} \times \frac{{A}_{E C S} [ i ]}{{A}_{ECS 0}} \times \frac{S A [ i ]}{S {A}_{0}} \times {θ}_{a c t} [ i ]$$
$${R}_{g a s} [ i ] = {C}_{8} + {C}_{9} \times \frac{{A}_{E C S} [ i ]}{{A}_{ECS 0}}$$
wherein,
V_{ocv} is an open circuit electromotive voltage of the polymer electrolyte fuel cell,
I₀[i] is an exchange current density,
R_{gas}[i] is a gas diffusion resistance,
A_{ECS0} is an initial value (constant) of the electrode catalyst surface area,
SA₀ is an initial value (constant) of activity per surface area of the noble metal-based catalyst particles, and
C₁ to C₉ are fitting coefficients.

8. The fuel cell performance estimation device according to claim 1, wherein
the first means further includes a means configured to sequentially acquire a high frequency impedance R[i], a temperature T_{FC}[i], a cathode air pressure P_{ca}[i], and a cathode air stoichiometric ST_{ca}[i] of the polymer electrolyte fuel cell at the time[i], and stores them in the memory, and wherein
the fourth means includes a means configured to calculate the IVₑₛₜ[i] expressed by the following formula (11):
$$\begin{matrix}[ Math . 7 ] & \\ {V}_{e s t} [ i ] = {V}_{O C V} - {C}_{10} \times {T}_{f c} [ i ] \times log ( \frac{I [ i ]}{{I}_{0} [ i ]} ) - {C}_{11} \times {T}_{f c} [ i ] \times log ( \frac{{C}_{4}}{{C}_{{O}_{2}} [ i ] - {C}_{6 \times } {R}_{g a s} [ i ] \times I [ i ]} ) - {C}_{12} \times R [ i ] I [ i ] & ( 11 )\end{matrix}$$
$${I}_{0} [ i ] = {C}_{7} \times \frac{{A}_{E C S} [ i ]}{{A}_{ECS 0}} \times \frac{S A [ i ]}{S {A}_{0}} \times {θ}_{act} [ i ] \times {e}^{\frac{{C}_{13}}{{T}_{f c} [ i ]}}$$
$${R}_{g a s} [ i ] = \frac{{P}_{c a} [ i ]}{{C}_{14}} + {C}_{9} \times \frac{{A}_{E C S} [ i ]}{{A}_{ECS 0}}$$
$${C}_{{O}_{2}} [ i ] = {C}_{15} \times \frac{{P}_{c a} [ i ]}{{T}_{f c} [ i ]} \times \frac{{c}_{16} + \frac{S {T}_{c a} [ i ] - 1}{{ST}_{c a} [ i ]}}{2}$$
wherein,
V_{ocv} is an open circuit electromotive voltage of the polymer electrolyte fuel cell,
I₀[i] is an exchange current density,
R_{gas}[i] is a gas diffusion resistance,
A_{ECS0} is an initial value (constant) of the electrode catalyst surface area,
SA₀ is an initial value (constant) of activity per surface area of the noble metal-based catalyst particles, and
C₄, C₆, C₇, and C₉, and C₁₀ to C₁₆ are fitting coefficients.

9. The fuel cell performance estimation device according to claim 1, further comprising:
(E) a fifth means configured to determine a failure of the polymer electrolyte fuel cell using the IVₑₛₜ[i].

10. The fuel cell performance estimation device according to claim 9, wherein the fifth means includes a means A configured to compare the V[i] at the time[i] with the Vₑₛₜ[i] obtained by substituting the I[i] into the IVₑₛₜ[i], and determine whether the polymer electrolyte fuel cell has failed.

11. The fuel cell performance estimation device according to claim 10, wherein the means A includes
(a) a means A1 configured to determine that the fuel cell has failed when an absolute value of a difference between the V[i] and the Vₑₛₜ[i] exceeds a first threshold value ε₁ or is equal to or greater than the ε₁,
(b) a means A2 configured to determine that the fuel cell has failed when a ratio (=V[i]/Vₑₛₜ[i]) of the V[i] to the Vₑₛₜ[i] is less than a second threshold value ε₂ or is equal to or less than the ε₂, and/or
(c) a means A3 configured to determine that the fuel cell has failed when a ratio (=(Vₑₛₜ[i]−V[i])/V[i]) of a difference between the Vₑₛₜ[i] and the V[i] to the V[i] exceeds a third threshold value ε₃ or is equal to or greater than the ε₃.

12. The fuel cell performance estimation device according to claim 9, wherein the fifth means includes a means B configured to calculate an average voltage Vₘ[T] and an average estimated voltage V_{m_est}[T] during a certain time interval ΔT using the V[i] and the Vₑₛₜ[i], respectively, compare the calculated Vₘ[T] with the calculated V_{m_est}[T], and determine whether the polymer electrolyte fuel cell has failed.

13. The fuel cell performance estimation device according to claim 12, wherein the means B includes
a means configured to calculate the Vₘ[T] using the following formula (12), and
a means configured to calculate the V_{m_est}[T] using the following formula (13):
$$\begin{matrix}[ Math . 8 ] & \\ {V}_{m} [ T ] = \frac{{\sum }_{i = T}^{T + Δ T} \{ V [ i ] \times ( I [ i ] == {I}_{S} ) \}}{{\sum }_{i = T}^{T + Δ T} ( I [ i ] == {I}_{S} )} & ( 12 )\end{matrix}$$
$${V}_{m\_est} [ T ] = \frac{{\sum }_{i = T}^{T + Δ T} \{ {V}_{est} [ i ] \times ( I [ i ] == {I}_{S} ) \}}{{\sum }_{i = T}^{T + Δ T} ( I [ i ] == {I}_{S} )} \qquad ( 13 )$$
$$( I [ i ] == {I}_{S} ) = \{ \begin{matrix}1 & ( I [ i ] = {I}_{S} ) \\ 0 & ( I [ i ] \neq {I}_{S} )\end{matrix}$$
wherein, Iₛ is a reference current when calculating the average voltage Vₘ[T] and the average estimated voltage V_{m_est}[T].

14. The fuel cell performance estimation device according to claim 12, wherein the means B includes
(a) a means B1 configured to determine that the fuel cell has failed when an absolute value of a difference between the Vₘ[T] and the V_{m_est}[T] exceeds a fourth threshold value ε₄ or is equal to or greater than the ε₄,
(b) a means B2 configured to determine that the fuel cell has failed when a ratio (=Vₘ[T]/V_{m_est}[T]) of the Vₘ[T] to the V_{m_est}[T] is less than a fifth threshold value ε₅ or is equal to or less than the εₛ, and/or
(c) a means B3 configured to determine that the fuel cell has failed when a ratio (=(V_{m_est}[T]−Vₘ[T])/Vₘ[T]) of a difference between the V_{m_est}[T] and the Vₘ[T] to the Vₘ[T] exceeds a sixth threshold value ε₆ or is equal to or greater than the ε₆.
